(19) United States
(12) Patent Application Publication
(10) Pub. No.: US 2017/0297534 A1
(43) Pub. Date: Oct. 19, 2017

(54) SYSTEM FOR WIPING A WINDSCREEN OF A VEHICLE

(71) Applicant: Valeo Systèmes d'Essuyage, Le Mesnil Saint Denis (FR)

(72) Inventor: Gérald Caillot, La Verriere (FR)

(73) Assignee: Valeo Systèmes d'Essuyage, Le Mesnil Saint Denis (FR)

(21) Appl. No.: 15/485,632

(22) Filed: Apr. 12, 2017

(30) Foreign Application Priority Data
Apr. 13, 2016 (FR) 1653279

(51) Int. Cl. B60S 1/32; B60S 1/38; B60S 1/34; B60S 1/40

(52) U.S. Cl. CPC B60S 1/32; B60S 1/40; B60S 1/3415; B60S 1/3425; B60S 1/38

(57) ABSTRACT

System for wiping a glazed surface of a vehicle, comprising
a wiper blade (110) comprising a connector (124),
a drive arm (112) for driving the wiper blade (110), the drive arm (1125 comprising at least one hinge means allowing the connector (124) to rotate relative to the drive am (112),
a connecting piece (23) in contact with the connector (124) and positioned on the hinge means, said connecting piece (23) comprising means for spraying liquid towards the glazed surface,
   characterized in that said connecting piece (23) is configured to follow a movement of the wiper blade (110) over the glazed surface.

### TECHNICAL FIELD

The present invention concerns in particular a system for wiping a windscreen of a vehicle, of the type comprising a wiper blade and a drive arm for this blade.

### PRIOR ART

Typically, a wiper blade for a vehicle windscreen comprises a longitudinal body and a wiping strip, generally made of rubber, intended to rub against the glass of the vehicle in order to remove water by sweeping it outside the driver's field of vision. The blade also comprises a longitudinal spine which stiffens the wiping strip so as to promote the application of this strip to the windscreen. The blade is carried by an arm which is driven by a motor in an angular reciprocating motion. The arm and the blade are connected together by means for connection and articulation around an axis, these means comprising in particular a connector which is attached to the body of the blade.

It is known to equip a vehicle with means for spraying screen-wash liquid towards the windscreen, the spray means being most often situated on the bonnet or grille plate below the windscreen. It has already been proposed to equip a wiper blade or its drive arm with the means for spraying screen-wash liquid. To optimize consumption of screen-wash liquid and the zones of impact of the liquid sprayed onto the windscreen, it is preferable for these spray means to be mounted on the blade rather than on the drive arm. The spray means of the blade are then supplied with screen-wash liquid by means for delivering liquid which are carried by the arm and which generally comprise a flexible pipe extending along the arm as far as the spray means of the blade.

This technology, however, has drawbacks. Firstly, this technology is costly since the blade and the arm are both equipped with means for circulation of the screen-wash liquid. Also, when the wiping strip of the blade is worn, the entire blade must be replaced by a new one even if its circulation means are still operational, which is not economic. Furthermore, on each change of blade, the delivery means of the arm must be disconnected from the spray means of the blade, which may lead to wear on the connecting parts of these means and cause leaks of screen-wash liquid after several blade replacement operations.

The invention proposes a simple, effective and economic solution to at least some of these problems.

### PRESENTATION OF THE INVENTION

The invention proposes a system for wiping a glazed surface of a vehicle, comprising:
a wiper blade comprising a connector,
a drive arm for driving the wiper blade, the drive arm comprising at least one hinge means allowing the connector to rotate relative to the drive arm,
a connecting piece in contact with the connector and positioned on the hinge means, the connecting piece comprising means for spraying liquid towards the glazed surface, characterized in that the connecting piece is configured to follow a movement of the wiper blade over the glazed surface.

The invention is particularly advantageous since it offers the benefits of the advantages linked to the spray means for screen-wash liquid which are mounted on a wiper blade, without the drawbacks described above. In fact, the connecting piece equipped with the spray means is configured to follow the movements of the blade, in particular around an axis of articulation between the blade and the arm, daring these movements over a windscreen. The spray means are therefore comparable to means mounted on the blade and offer the benefits of the advantages linked to this technology.

Also, according to one embodiment, the connecting piece is mounted movably in rotation on the arm, in particular directly thereon, and is carried by the arm when the blade is separated from the arm. It is understood that it is not necessary to disconnect the liquid delivery means from the spray means of the connecting piece during a change of wiper blade, since these means are carried by the arm and the connecting piece. The abovementioned risks of leakage are therefore substantially reduced. Finally, the wiper blade may be of a conventional type without screen-wash spray means, and hence relatively cheap.

The connecting piece is positioned on the hinge means provided on the arm, in particular by threading at least part of this means into an opening of the connecting piece. The connecting piece is then in direct physical contact with the hinge means.

According to one embodiment, the wiper system comprises a retaining means between the connecting piece and the drive arm for retaining the connecting piece on the drive arm.

In the system according to the invention, the hinge means comprises:
a shaft which is transverse to an extension direction of the drive arm and engaged in a housing of the connector,
a stop means for locking the connecting piece on the drive arm.

The retaining means and the stop means are arranged on either side of the shaft, in the longitudinal direction of the drive arm.

The invention also concerns an assembly for wiping a glazed surface of a vehicle, comprising:
a wiper blade comprising a connector,
a connecting piece in contact with the connector, the connecting piece comprising at least one passage opening for a hinge means allowing the wiper blade to rotate relative to a drive arm, the connecting piece being attached to the wiper blade in order to follow a movement of the wiper arm over the glazed surface.

According to various characteristics of the invention taken alone or in combination, it may be provided that:
the connecting piece comprises at least one notch intended to receive a deflector of the wiper arm,
the connecting piece comprises a retaining means configured for retaining the connecting piece on the drive arm of the wiper blade,
the retaining means is a lateral tab which comprises at least one stop configured to cooperate with the drive arm,
the retaining means is elastically deformable in flexion,
the spray means comprise openings for spraying liquid, in particular screen-wash liquid,
the connecting piece is a cap configured to cover at least partially the connector of the wiper blade.

The invention also concerns an assembly for driving a wiper blade of a vehicle, comprising:
a drive arm configured for driving the wiper blade, the drive arm comprising a hinge means allowing the wiper blade to rotate relative to the drive arm,
a connecting piece positioned on the hinge means, the connecting piece comprising means for spraying liquid towards the glazed surface, characterized in that the connecting piece is intended to be attached to the wiper blade in order to follow a movement of the wiper blade over the glazed surface.

According to various characteristics of the invention taken alone or in combination, it may be provided that:
the hinge means comprises:
   a shaft which is transverse to an extension direction of the drive arm and able to engage in a housing situated on the wiper blade, in particular situated in a connector fitted to the wiper blade, and
   a stop means for locking the connecting piece on the drive arm,
the drive assembly comprises a retaining means between the connecting piece and the drive arm, for retaining the connecting piece on the drive arm,
the retaining means is a tab which comprises at least one stop configured to cooperate with the drive arm,
the retaining means is elastically deformable in flexion,
a wall of the tab extends parallel or substantially parallel to the shaft,
the spray means comprise openings for spraying liquid,
the connecting piece comprises at least one passage opening intended to receive said shaft,
the connecting piece is for example a cap configured to cover fully a connector of the wiper blade. This cap may be configured to cover at least partially the connector of the blade, in particular by housing this connector in an inner volume of the connecting piece,
the connecting piece may comprise at least one passage opening which defines the articulation axis and which is integral to the arm. The connecting piece may be provided with a single passage orifice for the shaft, which allows retention of an appropriate aesthetic aspect of the connecting piece on the side of the lateral flank of the connecting piece opposite that which receives the passage opening.

In the case where the correcting piece is a cap which covers the blade connector, the opening of the connecting piece is advantageously aligned with the housing of the connector when the connecting piece is in its mounted position on the connector.

The retaining means mentioned above in connection with the system, or with one or the other of the assemblies, is a device which prevents the connecting piece from becoming detached from the arm.

The retaining means is for example formed by a protuberance emerging from the connecting piece.

The retaining means guarantees that one of the openings of the connecting piece remains engaged on the shaft of the hinge means when the connecting piece is moved on the shaft.

The connecting piece may thus comprise at least one passage opening for a shaft which defines the articulation axis and which is integral to the arm.

Preferably, the shaft is fixed by one of its ends to the arm. The connecting piece may be mounted movably, directly on the arm, by insertion of the shaft in the opening of the connecting piece. This opening is preferably a transverse opening which extends substantially perpendicular to a longitudinal axis of the connecting piece.

Advantageously, the shaft of the arm is centred and guided in a cylindrical housing of a connector of the arm. The connector is attached to the arm. In the case where the connecting piece is a cap which covers the connector of the blade, the opening of the connecting piece is advantageously aligned with the housing of the connector when the connecting piece is in its mounted position on the connector.

This fixing technology, generally known as “side lock” in the technical field, generally comprises a shaft, one end of which is fixed to one end of the arm and which is engaged by axial translation in a cylindrical housing of the connector of the arm. The arm generally comprises stop means which lock the blade relative to the arm.

The stop means of the arm and/or the retaining means are advantageously configured to limit the travel of the connecting piece relative to the arm in translation along the axis defined by the shaft and/or in rotation around this axis.

The stop means or the retaining means may take the form of a tab which extends parallel to the axis and in which the shaft extends for the most part.

The tab, or at least one of said tabs, is preferably elastically deformable, for example in flexion. This capacity for elastic deformation may be useful for the possibility of removing the connecting piece from the arm.

In the system or in the assemblies presented in the present document, it is understood that the connecting piece is configured to follow a movement of the wiper blade over the glazed surface, in particular by being attached to the connector fitted to the wiper blade. Following the movement of the wiper blade over the glazed surface means that the wiper blade is movable in rotation about an axis of the hinge means, so as to allow a degree of freedom in rotation relative to the drive arm, and thus follow a path of the contour of the glazed surface.

The present invention furthermore concerns a method for assembling a wiper system as described above, characterized in that it comprises the steps consisting of:
a) moving the connecting piece, in particular in translation, along the shaft so as to move the connecting piece away from the drive arm until the retaining means is in contact with the surface of an inner wall of the drive arm,
b) mounting the connecting piece on a connector of the wiper blade, and
c) moving the connecting piece and the wiper blade, in particular in translation, along the shaft so as to bring the connecting piece and the wiper blade back towards the drive arm, by engaging the shaft in a housing situated on the connector of the blade.

The method may comprise, before step a), a step 0) consisting of moving the connecting piece in rotation about the axis along which the shaft extends, until the retaining means comes to rest on an inner surface of an upper wall of the drive arm.

The method may comprise, after step c), a step d) consisting of moving the connecting piece in rotation around the axis defined by the shaft until the connecting piece comes to rest on the stop means of the drive arm.

The retaining means and the stop means are arranged on either side of the shaft in the longitudinal direction of the drive arm, such that the rotation according to step 0) is operated in a direction opposite the rotation applied in step d).

### DESCRIPTION OF THE FIGURES

The invention will be better understood and further details, characteristics and advantages of the invention will appear from reading the following description, given merely as a non-limitative example, with reference to the attached drawings in which:

FIG. 1 is an exploded, perspective view of a system for wiping a windscreen according to the prior art,

FIG. 2 is a partial, perspective view of a system for wiping a windscreen according to the invention,

FIGS. 3 to 5 are other partial, perspective views of the system of FIG. 2 and represent the steps in a method for removal and separation of the wiper arm from the system,

FIG. 6 is a partial, perspective view of a drive arm of a wiper system according to a variant embodiment of the invention, and

FIGS. 7A and 7B are views from below of the arm of FIG. 6 and represent the steps in a method for mounting a blade on the arm.

### DETAILED DESCRIPTION

It should be noted that the figures present the invention, in a detailed fashion to allow implementation of the invention, said figures naturally helping define the invention where applicable.

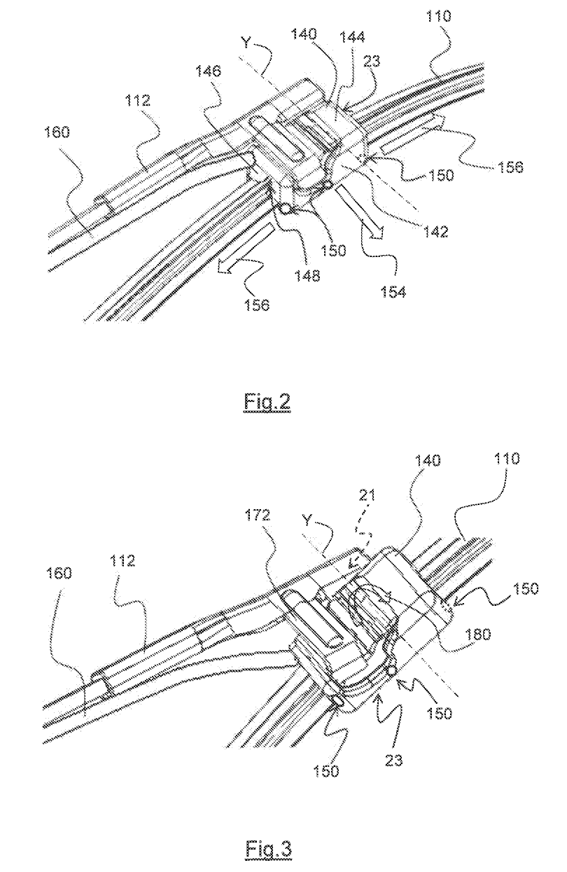

In the description below, in particular for the description of FIGS. 2 to 7B, the terms “longitudinal” and “lateral” relate to the orientation of a drive arm of a wiper blade or of the wiper blade. The longitudinal direction corresponds to the main axis of the arm or blade in which it extends, while the lateral directions correspond to straight lines perpendicular to the longitudinal direction of the arm or blade in its plane. For the longitudinal directions, the terms “outer” and “inner” are understood relative to the fixing point of the blade on the drive arm, the term “inner” corresponding to the part where the arm and a blade half extend. Finally, the terms “upper” and “lower” correspond to directions perpendicular to the plane in which the arm or blade extends, the term “lower” containing the plane of the glazed surface.

The terms “substantially parallel” or “substantially perpendicular/transverse” include a degree of freedom of plus or minus 5°.

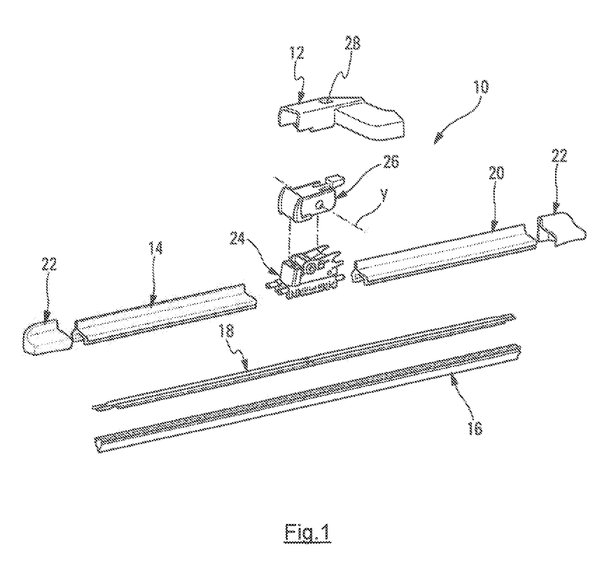

FIG. 1 illustrates a wiping system according to the prior art for a windscreen of a vehicle, in particular a motor vehicle. The system comprises a windscreen wiper blade 10 and a drive arm 12 for this blade, the arm 12 being partially shown and intended to be driven by a motor to follow an angular reciprocating movement to remove water and any other undesirable elements covering the windscreen.

The blade 10 here comprises a longitudinal body 14, a longitudinal wiper strip 16, generally made of rubber, and at least one longitudinal spine 18 which stiffens the strip 16 and promotes its application to the windscreen.

The body 14 of the blade 10 comprises an upper aerodynamic deflector 20 intended to improve the function of the system, the aim of this deflector 20 being to improve the adhesion of the blade 10 to the windscreen and hence the aerodynamic performance of the system.

The blade 10 also comprises holders or fixing clips 22 for the strip 16 and the spine 18 on the body, these clips 22 being situated at each of the longitudinal ends of the body 14.

The body 14 of the blade is here made of two independent parts which are arranged substantially end to end and are connected together via an intermediate connector 24.

To ensure mounting on the arm 12, the blade 10 comprises an adapter 26 mounted on the connector 24 and allowing articulation of the blade 10 relative to the arm 12. The articulation of the blade 10 relative to the arm 12 is an articulation following a rotational movement around a rotation axis Y which stands perpendicular to the longitudinal axis in which the body 14 of the blade 10 extends. The blade 10 must in fact have at least one degree of freedom in rotation relative to the arm 12, more specifically relative to an end piece 28 of the arm 12, to allow the blade 10 to follow the curvature of the windscreen.

The invention concerns a particular type of wiper system which is equipped with means for spraying screen-wash liquid onto a glazed surface of the vehicle, these spray means being carried by or formed on a connecting piece which is mounted on the drive arm so as to be movable in rotation around axis Y, such that this piece may follow the movements of the wiper blade. The connecting piece equipped with the spray means is configured to be carried by the arm when the blade is separated from the arm.

The description below presents a wiper system according to the invention, but it is apparent that the characteristics common to the system and the assemblies may be applied to the wiper assembly or to the drive assembly.

FIGS. 2 to 5 show an embodiment of the wiper system according to the invention; this system comprises a wiper blade 110 which here is a flat blade, similar to that in FIG. 1. The system also comprises a drive arm 112 to carry and drive the wiper arm 110 in rotation.

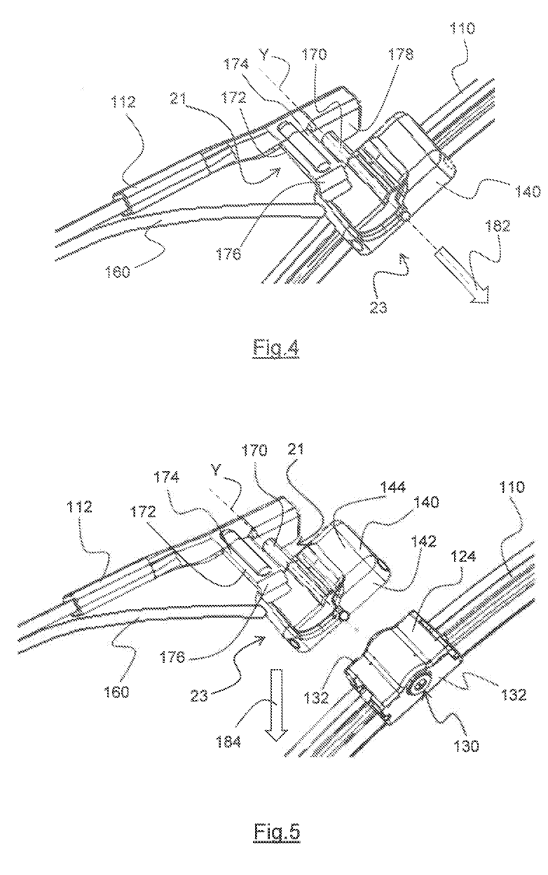

As described above, the wiper blade 110 comprises a connector 124 connecting the wiper blade 110 to the drive arm 112. The connector 124 here has a generally parallelepipedic form and comprises a transverse cylindrical housing 130. The cylindrical housing is transverse in the sense that it extends substantially perpendicularly to the longitudinal axis in which the wiper blade 110 extends (FIG. 5). The longitudinal ends of the housing 130 open respectively onto two side faces 132 of the connector 124 which are oriented in substantially opposite directions, substantially parallel to the longitudinal axis of the blade 110. The blade 110 may comprise the other characteristics described above with reference to FIG. 1.

The connecting piece 23 carrying the liquid spray means is here intended to cap the connector 124 of the blade 110, in particular integrally. The connecting piece 23 is thus in contact with the connector 124.

The connecting piece 23 is for example a cap 140 which, when mounted on the connector 124 as shown in FIGS. 2 to 4, covers the connector 124 partially or fully. The cap 140 has a cross section substantially in the form of an inverted U, and comprises two substantially parallel lateral flanks 142. The lateral flanks 142 are connected to an upper wall 144 of the cap by their upper longitudinal edges.

The transverse distance or dimension (relative to the longitudinal axis of the blade) between the lateral flanks 142 of the cap is greater than the width of the connector 124 (or the transverse distance or dimension between the lateral faces 132 of the connector), such that the cap 140 may be mounted on the connector 124 so that the lateral flanks 142 of the cap extend substantially parallel and facing the lateral flanks 132 of the connector, as shown in FIGS. 2 to 4. In other words, in the mounting position shown in FIGS. 2 to 4, the connector 124 is housed in an inner cavity, otherwise known as the inner volume of the cap 140, defined by the upper wall 144 and lateral flanks 142.

The connecting piece 23 comprises at least one fixing means for attaching this to the connector of the wiper blade. According to an exemplary embodiment, the fixing means takes the form of at least one clip hook arranged on an edge of the connecting piece 23, and able to grip a ridge of the connector. Thus the connecting piece 23 or the cap 140 follows the movements of the wiper blade over the glazed surface, in particular the movements around the rotation axis Y.

At least one of the lateral flanks 142 of the cap may comprise a passage opening 197 (visible only on drawings 7A and 7B) which, when the cap 140 is mounted on the connector 124, is aligned to the axis of the cylindrical housing 130 of the connector. This opening has an orientation which is substantially transverse relative to the longitudinal axis of the blade. The lateral flank opposite that with the opening may have no opening.

The cap 140 may also have a longitudinal section substantially in the form of an inverted U, and comprise two end flanks 146 which are substantially parallel to each other and connected both to the upper wall 144 and to the lateral flanks 142.

The longitudinal distance or dimension between the end flanks 146 of the cap 140 is greater than the length of the connector 124, such that the cap 140 may be mounted on the connector 124 as explained above.

The end flanks 146 of the cap may comprise notches 148 formed to receive the parts of the deflector of the blade 110, as shown in FIG. 2.

The cap 140 comprises means for spraying liquid, in particular screen-wash liquid, which comprise at least spray openings 150 intended to be oriented towards the glazed surface of the vehicle, such as the windscreen or rear screen. These spray openings 150 may open at the level of at least one of the lateral flanks 142 of the cap 140, as indicated diagrammatically in the drawings. In the case where only one of the lateral flanks 142 is equipped with the spray openings 150, the latter are preferably situated on the side of the rising direction of movement of the wiper system over the windscreen. The lateral flank 142 equipped with the spray openings 150 may be the lateral flank opposite that comprising said opening and intended to be aligned with the housing 130 of the connector 124.

In the case where the two lateral flanks 142 are equipped with such openings 150, they are then able to spray liquid when the blade 110 is moving in the rising direction and in the descending direction. In the example shown, the or each lateral flank 142 is equipped with three spray openings 150, one of which is situated substantially in the middle of the lateral flank 142 and oriented to spray liquid onto the glared surface in a direction substantially perpendicular to the longitudinal axis of the blade (arrow 154 in FIG. 2), and the other two spray openings 150 of which are situated respectively at the two longitudinal ends of the lateral flank 142, and are oriented to spray liquid towards the glazed surface in substantially opposite directions, parallel to the longitudinal axis of the blade (arrow 156 in FIG. 2).

As a variant, the spray openings 150 may be replaced by liquid atomization nozzles or jets.

The spray openings 150 are supplied with screen-wash liquid via liquid delivery means which here comprise a flexible pipe 160, for example made of rubber, which extends along the arm 112 and is fixed thereon by appropriate means. One end of the pipe 160 is connected to the connecting piece 23, wherein the latter may comprise a sleeve for receiving said pipe.

The drive arm 112 has an elongate form and comprises a hinge means 21 at its free end. The hinge means 21 allows rotation of the wiper blade through a certain angle around the rotation axis Y. The hinge means 21 comprises a cylindrical shaft 170 which is transverse to the longitudinal direction in which the drive arm 112 extends. This shaft 170 defines the axis Y of rotation of the blade 110 relative to the arm 112. As shown on the drawings, the shaft 170 and the axis Y are substantially perpendicular to the longitudinal axis of the drive arm 112 and the wiper blade 110 when the latter is mounted on the arm.

The shaft 170 is fixed at one of its longitudinal ends to the arm 112 and configured to be engaged by sliding into the cylindrical housing 130 of the connector 124 situated on the blade 110, passing through the said opening in one of the lateral flanks 142 of the cap 140. The cap 140 is thus positioned, in particular threaded onto the shaft 170. This engagement is achieved by translation of the blade 110 and cap 140 mounted on the connector 124 of the blade 110 towards the drive arm 112, in a direction parallel to axis Y and congruent with rotation axis Y (FIGS. 2 and 3).

The engagement of the shaft 170 in the connector 124 situated on the wiper blade 110 allows the cap 140 and the wiper blade 110 to rotate around the rotation axis Y. This engagement also allows the wiper blade 110 to be locked relative to the cap 140, and the cap 140 relative to the blade 110.

The arm 112, in particular its hinge means 21, also comprises stop means. The stop means are also situated at the free end of the arm 112. The stop means is for example a transverse tab 172 intended to cooperate with the cap 140 in order to look the cap 140 and the blade 110 relative to the drive arm 112.

The transverse tab 172 has a generally L-shaped form and has a first transverse wall 174 extending from the arm, substantially parallel to the shaft 170 and at a distance therefrom. The transverse tab 172 has a second wall 176 connected to the first wall 174 at its free end. The second wall 176 forms a stop rim 176. For example, the stop rim 176 forms a right angle with the first wall 174. In the example shown, the transverse tab is connected by one of its ends to an upper edge of the drive arm 112, its opposite end being connected to the rim 176 which extends downward, i.e. on the side opposite the said upper edge of the arm.

In the case where the end part of the drive arm 112 comprises the shaft 170, and the tab 172 has a lateral face 178 which is relatively flat and substantially parallel to the longitudinal axis of the arm, the rim 176 may be considered as substantially parallel to this lateral face 178 (FIG. 4).

The transverse tab 172 has a transverse length or dimension (relative to the longitudinal axis of the arm) which is greater than that of the cap 140 measured in the same direction, such that the cap may be inserted between the arm 112 and the rim 176 of the tab, and the latter may come to rest or at least extend above the upper wall 144 of the cap, as shown on FIG. 2. Thus the transverse tab 172 allows blockage of the connecting piece 23 and the blade 110 in rotation about axis Y beyond a certain range of predefined angular value. The transverse tab 172 also allows transverse blocking of the connecting piece 23.

In the position shown in FIG. 2, the blade 110 and the cap 140 are locked relative to the drive arm 112, in particular by the transverse tab 172 and its stop rim 176, the latter resting on the lateral flank 142 of the cap opposite the drive arm 112, so as to block the cap and blade in translation along axis Y.

FIG. 2 shows the wiper system according to the invention in the operating position, the blade 110 being connected to the arm 112 and locked relative thereto. FIGS. 3 to 5 show, in this order, steps of removing the blade from the arm, in order for example for the blade to be replaced e.g. by a new one.

During a first step shown in FIG. 3, the wiper blade 110 is moved in rotation around axis Y relative to the drive arm 112 (arrow 180) so as to move it away from the tab 172 of the arm, until the rim 176 of this tab is no longer facing the lateral flank 142 of the cap and hence can no longer cooperate therewith. The pivot angle of the blade may be of the order of 20° to 40° approximately. The cap 140 which is attached to the connector 124 follows the movement of the blade over the glazed surface. The pipe 160 is flexible and allows pivoting of the cap 140 by deforming elastically.

During another step shown in FIG. 4, the blade 110 is moved in translation along axis Y in order to move it away from the arm 112 (arrow 182) until the shaft 170 situated on the drive arm 112 is withdrawn from the housing 130 situated on the connector 124 of the wiper blade 110. The length of this movement is in particular a function of the length of the shaft 170. Once the shaft 170 has been withdrawn from the housing 130 of the connector 124, the connector 124 may be separated from the cap 140 by axial translation of the blade 110 in a direction substantially perpendicular to the longitudinal axis of the arm or blade 110 (arrow 184 in FIG. 5). It is noted that, in this FIG. 5, the cap 140 remains on the arm when the blade is removed and withdrawn from the arm. It is here the engagement of the shaft 170 in the passage opening 197 (visible in FIG. 7A, 7B) of the cap 140 which retains the cap relative to the drive arm 112, the cap 140 also being connected to the pipe 160. It is also found that the cap 140 is mounted directly pivoting on the arm 112, again by engagement of the shaft 170 in the opening of the cap 140.

The blade 110 previously removed, or a new blade, may be mounted on the arm 112 by repeating the abovementioned operations in reverse. More precisely, the connector 12 4 of the blade is engaged in the inner volume of the cap 140 by axial translation of the blade towards the cap 140 in a direction substantially perpendicular to the longitudinal axis of the drive arm.

In the position shown in FIG. 4, the cap 140 covers the connector 124 of the blade 110. The shaft 170 of the drive arm 112 is engaged in the housing 130 of the connector 124 by axial translation of the blade along axis Y towards the drive arm 112, until the cap 140 comes to rest laterally with its lateral flank 142, comprising the passage opening of the shaft 170, on the lateral face 178 of the arm 112. The blade 110 is then moved in rotation around axis Y (FIG. 3) until the wall 144 of the cap comes to rest on the transverse tab 172. In this position shown in FIG. 2, the stop rim 176 of the transverse tab 172 locks the cap 140 and hence the blade 110 relative to the drive arm 112 along axis Y. The cap 140 may then be attached to the connector 124, in particular by clipping it thereto. Thus the connecting piece 23 is attached to the connector 124 of the wiper blade 110.

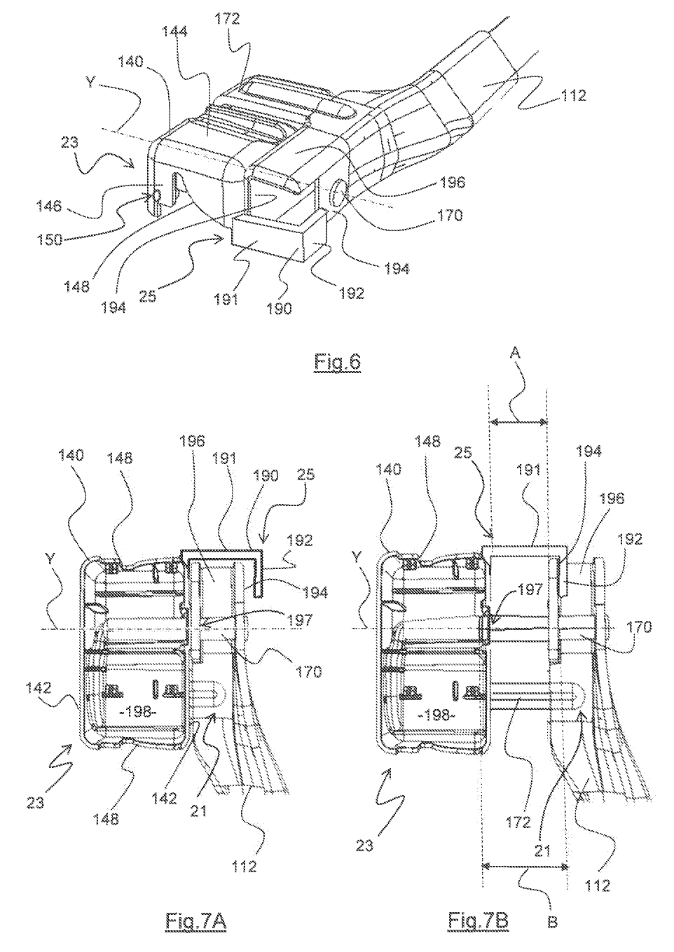

FIGS. 6, 7A and 7B show a variant embodiment of the invention which comprises, in addition to the characteristics described above with reference to FIGS. 2 to 5, retaining means 25 for the connecting piece 23 on the drive arm. These retaining means 25 may be carried by the connecting piece 23 and are intended to cooperate with the arm 112. These retaining means 25 may also be carried by the drive arm 112 and are intended to cooperate with the connecting piece 23.

The retaining means 25 may be made of one piece with the connecting piece 23 or the drive arm 112.

These retaining means here comprise a lateral tab 190. In the case shown, the lateral tab 190 is carried by the cap 140 at a longitudinal end thereof. The lateral tab 190 here extends towards a side of the cap 140 substantially in the extension of an end flank 146 thereof. The lateral tab 190 is parallel or substantially parallel to this end flank 146, and hence substantially parallel to the shaft 170 of the arm 112 and to the axis Y of rotation of the cap 140 relative to the arm 112, in the mounted position.

The lateral tab 190 emerges from the longitudinal end of the cap 140 which is intended to be situated at the free end of the arm 112 when the cap 140 is in the operating position shown in FIG. 6. In this position, the lateral tab 190 extends forward (or towards the outside) from the free end of the arm 112. This free end of the arm 112 has an inverted U section and comprises two lateral walls 194 which are substantially parallel and connected together by an upper wall 196.

The lateral tab 190 has a generally L-shaped form and has a first wall 191 and a second wall 192 forming a stop. The second wall 192 forms for example a right angle with the first wall 191. The stop formed by the second wall 192 is intended to cooperate with the end of the arm 112.

The second wall 192 is thus configured to come into contact with a lateral inner face of a lateral wall 194 of the arm, as shown on FIG. 7B. This contact limits the movement in translation of the cap 140 along axis Y relative to the drive arm 112. This movement is thus defined firstly by this cooperation between the second wall 192 of the lateral tab 190 and the arm 112, and secondly by the stop of the cap 140 on the lateral wall 194 of the arm 112.

Also, the first wall 191 of the lateral tab 190 has a length A which is always less than a length B corresponding to a tree length of the shaft 170 over which the cap 140 may be inserted. Thus the length A or the wall 191 is such that, in all cases, it prevents the cap 140 from detaching from the drive arm 112. The length A of the first wall 191 and the length B of the shaft 170 are measured in mutually parallel directions.

According to a variant embodiment, the second wall 192 is configured to rub on a lower face of the wall 196 of the arm 112 during its translation movement. This limits the travel of the cap 140 in rotation around axis Y relative to the arm, during the phase of removing the wiper blade. The rotational travel is thus defined firstly by this cooperation between the second wall 192 of the lateral tab 190 and the arm 112, and secondly by the cooperation of the upper wall 144 of the cap with the transverse tab 172 carried by the arm 112. The transverse tab 172 and lateral tab 190 may allow an angular deflection of 90° for example around axis Y when the retaining means 25 is inactive. More precisely, the angular deflection authorized by the lateral tab 190 is greater than the minimum angular deflection necessary to allow release of the cap 140 relative to the transverse tab 172.

The operating position of the cap 140 shown in FIG. 6 corresponds to that shown in FIG. 2. The position of the cap 140 shown in the view in FIG. 7A corresponds to that shown in FIG. 3 in which the cap 140 has been moved in rotation around axis Y, the rim 132 of the tab 190 resting on the lower face of the wall 196 of the arm 112. The position of the cap 140 shown in the view in FIG. 7B corresponds to that shown in FIG. 4 in which the cap is removed from the arm and the wiper blade has been withdrawn. In the views in FIGS. 7A and 7B, the position of the opening 197 of the cap 140, for passage of the shaft 170 of the drive arm 112, may be seen. It is also clear that, in the position shown in the view in FIG. 7B, the shaft 170 leaves the inner volume 198 of the cap 140 free, and thus allows insertion of the connector 124 of the blade into this inner volume 198, or its withdrawal therefrom.

In FIGS. 6, 7A and 7B, the delivery means for the screen-wash liquid and the spray means for this liquid carried by the cap 140 have not been shown for reasons of greater clarity.

1. A system for wiping a glazed surface of a vehicle, comprising:
a wiper blade comprising a connector;
a drive arm for driving the wiper blade, the drive arm comprising at least one hinge means allowing the connector to rotate relative to the drive arm; and
a connecting piece in contact with the connector and positioned on the hinge means, the connecting piece comprising means for spraying liquid towards the glazed surface,
wherein the connecting piece is configured to follow a movement of the wiper blade over the glazed surface.

2. The system according to claim 1, further comprising a retaining means between the connecting piece and the drive arm for retaining the connecting piece on the drive arm.

3. The system according to claim 2, wherein the at least one hinge means comprises:
a shaft which is transverse to an extension direction of the drive arm (112) and engaged in a housing of the connector, and
a stop means for locking the connecting piece on the drive arm.

4. An assembly for wiping a glazed surface of a vehicle, comprising:
a wiper blade comprising a connector; and
a connecting piece in contact with the connector, the connecting piece comprising means for spraying liquid towards the glazed surface, characterized in that the connecting piece comprises at least one passage opening for a hinge means allowing the wiper blade to rotate relative to a drive arm, the connecting piece being attached to the wiper blade to follow a movement of the wiper arm over the glazed surface.

5. The assembly according to claim 4, wherein the connecting piece comprises a retaining means configured for retaining the connecting piece on a drive arm of the wiper blade.

6. The assembly according to claim 5, wherein the retaining means is a lateral tab which comprises at least one stop configured to cooperate with the drive arm.

7. The assembly according to claim 5, wherein the retaining means is elastically deformable in flexion.

8. The assembly according to claim 4, wherein the connecting piece is a cap configured to cover at least partially the connector of the wiper blade.

9. An assembly for driving a wiper blade of a vehicle, comprising:
a drive arm configured for driving the wiper blade, the drive arm comprising a hinge means allowing the wiper blade to rotate relative to the drive arm; and
a connecting piece positioned on the hinge means, the connecting piece comprising means for spraying liquid towards the glazed surface,
wherein the connecting piece is configured to be attached to the wiper blade to follow a movement of the wiper blade over the glazed surface.

10. The assembly according to claim 9, wherein the hinge means comprises:
a shaft which is transverse to an extension direction of the drive arm and able to engage in a housing situated on the wiper blade; and
a stop means for locking the connecting piece on the drive arm.

11. The assembly according to claim 9, further comprising a retaining means for retaining the connecting piece on the drive arm.

12. The assembly according to claim 11, wherein the retaining means is a lateral tab which comprises at least one stop configured to cooperate with the drive arm.

13. The assembly according to claim 12, wherein the retaining means is elastically deformable in flexion.

14. The assembly according to claim 12 wherein a first wall of the lateral tab extends substantially parallel to the shaft.

15. The assembly according to claim 9, wherein the connecting piece comprises at least one passage opening to receive the shaft.

16. The assembly according to claim 9, wherein the connecting piece is a cap configured to cover at least partially a connector of the wiper blade.

17. The assembly according to claim 4 wherein the spray means comprise openings for spraying liquid.

18. A method for assembling a wiper system according to claim 3, comprising:
a) moving the connecting piece in translation along an axis defined by the shaft so as to move the connecting piece away from the drive arm until the retaining means is in contact with the surface of a side wall of the drive arm,
b) mounting the connecting piece on the connector of the wiper blade; and
c) moving the connecting piece and the wiper blade along the axis defined by the shaft to bring the connecting piece and the blade back towards the drive arm, and engaging the shaft in a housing situated on the connector of the blade.

19. The method according to claim 18, further comprising, before step a), moving the connecting piece in rotation about the axis defined by the shaft until the retaining means comes to rest on an inner surface of an upper wall of the drive arm.

20. The method according to claim 18, further comprising, after step c), moving the connecting piece in rotation around the axis defined by the shaft until the connecting piece comes to rest on the stop means of the drive arm.
